(19) United States
(12) Patent Application Publication
(10) Pub. No.: US 2015/0309368 A1
(43) Pub. Date: Oct. 29, 2015

(54) DISPLAY DEVICE HAVING EYE PROTECTION FUNCTION

(71) Applicant: HON HAI PRECISION INDUSTRY CO., LTD., New Taipei (TW)

(72) Inventors: DING-YIH SU, New Taipei (TW); DENG-KAI CHANG, New Taipei (TW); CHENG-TEH SHAO, New Taipei (TW); LI-CHIAO HUANG, New Taipei (TW); CHIA-YI TSAI, New Taipei (TW); CHIEN-MING HUANG, New Taipei (TW); KUAN-WEI CHOU, New Taipei (TW); PEI-CHUN TSAI, New Taipei (TW); MEI-JUN YEH, New Taipei (TW); YUNG HUNG LIU, New Taipei (TW); YING-YI CHEN, New Taipei (TW); LI-LIEN CHENG, New Taipei (TW)

(21) Appl. No.: 14/692,901

(22) Filed: Apr. 22, 2015

(30) Foreign Application Priority Data
Apr. 23, 2014 (TW) 103114763

(51) Int. Cl. G02F 1/1335; G02B 5/26; G02B 5/22

(52) U.S. Cl. CPC G02F 1/133621; G02B 5/22; G02B 5/26; G02F 1/133528; G02F 2001/133624

(57) ABSTRACT

A display device is provided. The display device includes a display panel and a backlight module. The backlight module is emits light to the display panel. the light emitted from the backlight module includes blue light having a peak wavelength not less than 455. The display device can reduce harmful to eyes of people.

### CROSS-REFERENCE TO RELATED APPLICATIONS

This application claims priority to Taiwanese Patent Application No. 103114763 filed on Apr. 23, 2014, the contents of which are incorporated by reference herein.

### FIELD

The subject matter herein generally relates to a display device.

### BACKGROUND

Display devices are widely used at present. A display device displays a colorful image by regulating a ratio of red light, green light, and blue light. However, the display device is harmful to eyes of people.

### BRIEF DESCRIPTION OF THE DRAWINGS

Implementations of the present technology will now be described, by way of example only, with reference to the attached figures.

FIG. 1 is a diagrammatic view of a first embodiment of a display device.

FIG. 2 is a diagrammatic spectrogram of light emitted from the display device.

FIG. 3 is a diagrammatic view of a second embodiment of a display device.

FIG. 4 is a diagrammatic view of a third embodiment of a display device.

FIG. 5 is a diagrammatic view of a fourth embodiment of a display device.

FIG. 6 is a diagrammatic view of a fifth embodiment of a display device.

FIG. 7 is a diagrammatic view of a sixth embodiment of a display device.

FIG. 8 is a diagrammatic view of a seventh embodiment of a display device.

FIG. 9 is a diagrammatic view of an eighth embodiment of a display device.

FIG. 10 is a diagrammatic view of a ninth embodiment of a display device.

FIG. 11 is a diagrammatic view of a tenth embodiment of a display device.

FIG. 12 is a diagrammatic view of an eleventh embodiment of a display device.

FIG. 13 is a diagrammatic view of a twelfth embodiment of a display device.

FIG. 14 is a diagrammatic view of a thirteenth embodiment of a display device.

FIG. 15 is a diagrammatic view of a fourteenth embodiment of a display device.

FIG. 16 is a diagrammatic view of a fifteenth embodiment of a display device.

FIG. 17 is a diagrammatic view of a sixteenth embodiment of a display device.

FIG. 18 is a diagrammatic view of a seventeenth embodiment of a display device.

FIG. 19 is a diagrammatic view of an eighteenth embodiment of a display device.

FIG. 20 is a diagrammatic view of a nineteenth embodiment of a display device.

FIG. 21 is a diagrammatic view of a twentieth embodiment of a display device.

FIG. 22 is a diagrammatic view of a twenty-first embodiment of a display device.

FIG. 23 is a diagrammatic view of a twenty-second embodiment of a display device.

FIG. 24 is a diagrammatic view of a twenty-third embodiment of a display device.

FIG. 25 is a diagrammatic view of a twenty-fourth embodiment of a display device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

A display device displays a colorful image by regulating a ratio of red light, green light, and blue light. Generally, a wavelength of the blue light in a spectrum is in a range from 400 nm to 500 nm. However, in our research, the blue light having a wavelength in a range from 415 nm to 455 nm is harmful to eyes of people. For the defects above, the embodiments of the present disclosure adjust a maximum energy wavelength of the blue light emitted from the display device away from 415 nm to 455 nm to reduce the harmful of the blue light to eyes. Specifically, the embodiments adjust a peak wavelength of the blue light emitted from the display device to not less than 455 nm.

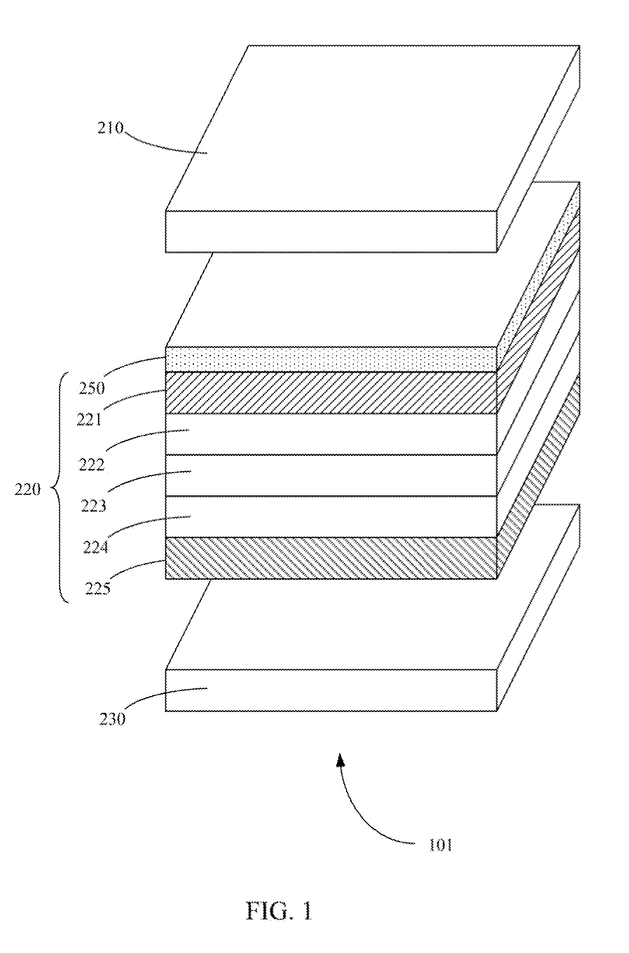

FIG. 1 is a first embodiment of a display device 101. The display device 101 includes a protection layer 210, a display panel 220, a backlight module 230, and a light modulation layer 250.

In this embodiment, the display panel 220 can be a liquid crystal display panel. The display panel 220 includes a first polarizer 221, a first substrate 222, a liquid crystal layer 223, a second substrate 224, and a second polarizer 225 which are stacked together in order. The first substrate 222 is opposite to the second substrate 224. The liquid crystal layer 223 is disposed between the first substrate 222 and the second substrate 224. The first polarizer 221 is disposed between the protection layer 210 and the first substrate 222. The second polarizer 225 is disposed between the backlight module 230 and the second substrate 224.

In this embodiment, the protection layer 210 can be a cover glass covering the display panel 220. The first substrate 222 can be a color filter substrate of the display panel 220. The second substrate 224 can be a thin film transistor (TFT) substrate. The first polarizer 221 allows light to pass therethrough along a first direction, and the second polarizer 225 allows light to pass therethrough along a second direction which is perpendicular to the first direction. The backlight module 230 emits light to the display panel 220. The light emitted from the backlight module 230 passes through the second polarizer 225, the second substrate 224, the liquid crystal layer 223, the first substrate 222, the first polarizer 221, and the protection layer 210 in order.

For reducing harmful of the blue light to the eyes of user, the light modulation unit 250 is configured to reduce a portion of the blue light having a wavelength from 415 nm to 455 nm emitted from the display device 101. A transmittance of the light modulation unit 250 for blue light in a wavelength less than 450 nm is less than 10%, a transmittance of the light modulation unit 250 for blue light having a wavelength over 470 nm is not less than 90%, and a transmittance of the light modulation unit 250 for blue light having a wavelength in a range from 450 nm to 470 nm increases when the wavelength of the blue light increases. The light modulation unit 250 can be disposed on any layer of the display panel, and also can be disposed on the protection layer 210 or the backlight module 230.

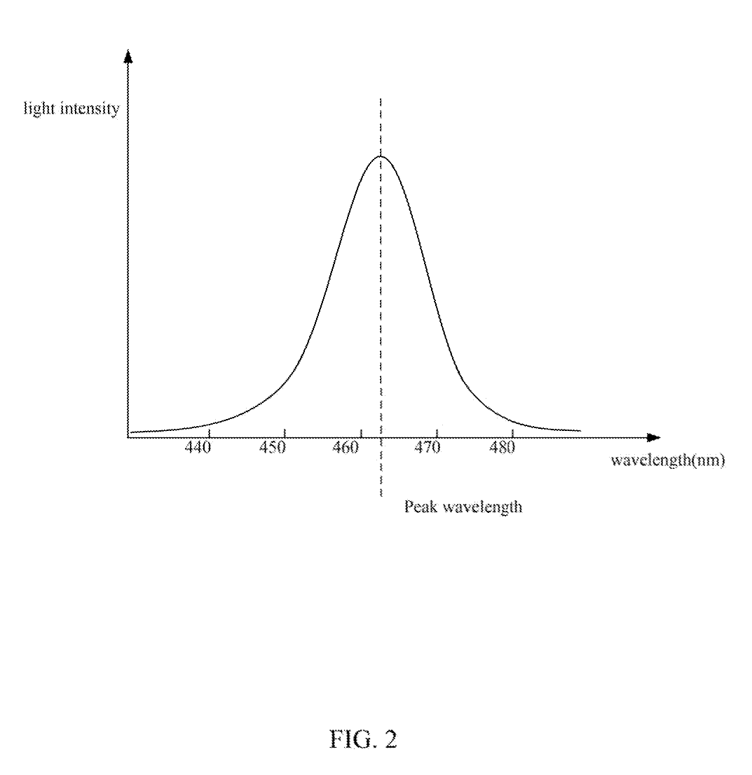

Referring to FIG. 2, the blue light emitted from the device 101 which peak wavelength in the spectrum is not less than 455 nm. A horizontal axis in FIG. 2 shows a wavelength of the blue light, and a vertical axis in FIG. 2 shows a light intensity of the blue light.

In this embodiment, the light modulation unit 250 is disposed on one side of the first polarizer 221 away from the first substrate 222. The light modulation unit 250 includes one or more absorb films or one or more reflect films. Specifically, in this embodiment, the light modulation unit 250 is composed of a compound of ramifications of niobium and silicon which are adhered on the first polarizer 221. In another embodiment, the compound of ramifications of niobium and silicon can also be deposited onto the first polarizer 221 via vacuum coating, ion plating, or magnetron sputtering. In another embodiment, the compound of ramifications of niobium and silicon can also be doped into the first polarizer 221.

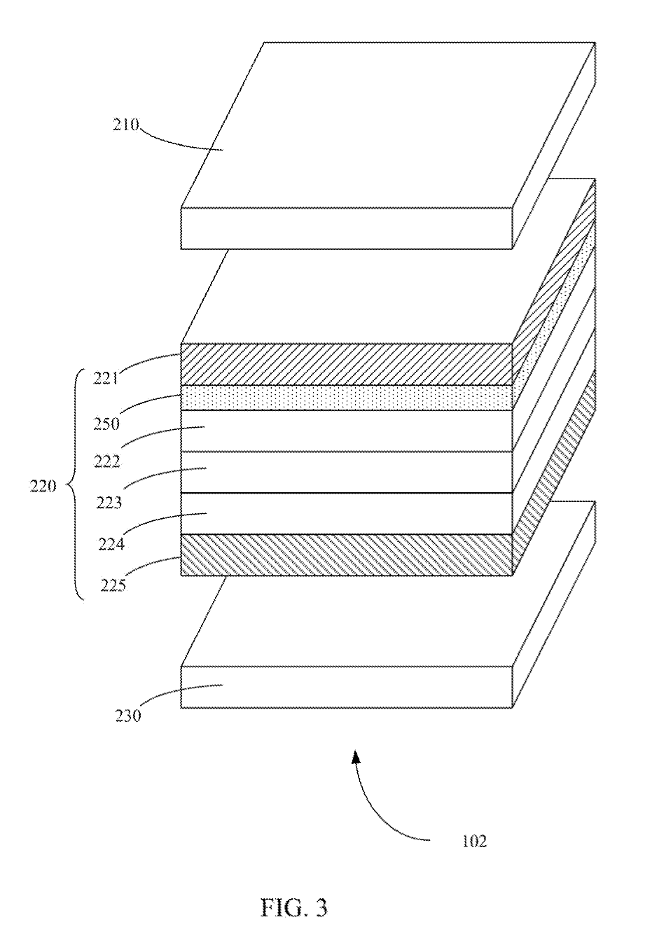

FIG. 3 is a second embodiment of a display device 102. The display device 102 is similar to the display device 101 in the first embodiment. Specifically, the display device 102 can also include the protection layer 210, the first polarizer 221, the first substrate 222, the liquid crystal layer 223, the second substrate 224, the second polarizer 225, the light modulation unit 250, and the backlight module 230 as well as the display device 101 in the first embodiment. However, the difference between the display device 102 and the display device 101 is that the light modulation unit 250 is disposed on one side of the first polarizer 221 adjacent to the first substrate 222. The light modulation unit 250 includes one or more absorb films or one or more reflect films. Specifically, in this embodiment, the light modulation unit 250 is composed of a compound of ramifications of niobium and silicon which are adhered on the first polarizer 221. In another embodiment, the compound of ramifications of niobium and silicon can also be deposited onto the first polarizer 221 via vacuum coating, ion plating, or magnetron sputtering. In another embodiment, the compound of ramifications of niobium and silicon can also be doped into the first polarizer 221.

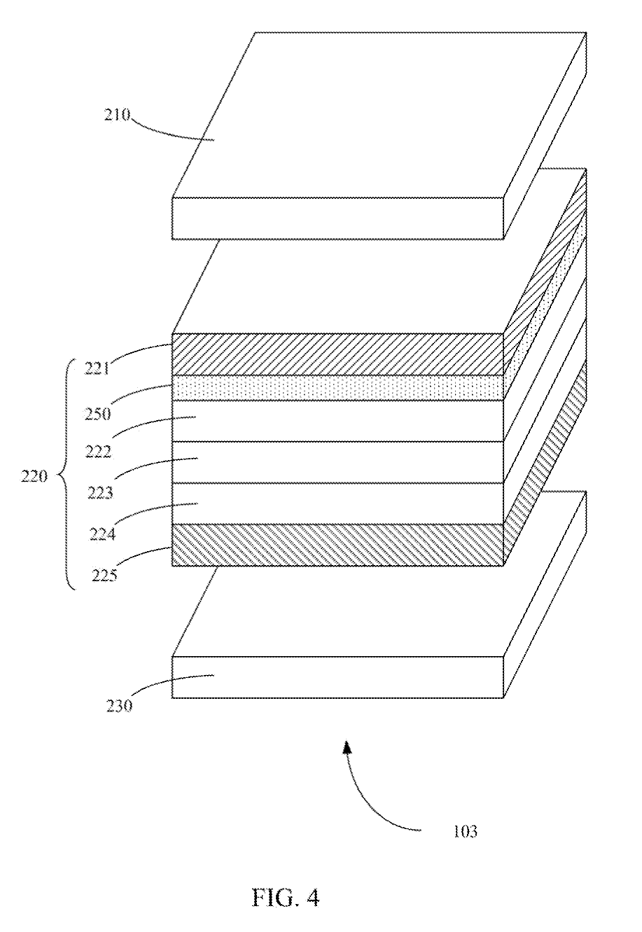

FIG. 4 is a third embodiment of a display device 103. The display device 103 is similar to the display device 101 in the first embodiment. Specifically, the display device 103 can also include the protection layer 210, the first polarizer 221, the first substrate 222, the liquid crystal layer 223, the second substrate 224, the second polarizer 225, the light modulation unit 250, and the backlight module 230 as well as the display device 101 in the first embodiment. The difference between the display device 103 and the display device 101 is that the light modulation unit 250 is disposed on one surface of the first substrate 222 adjacent to the first polarizer 221. The light modulation unit 250 includes one or more absorb films or one or more reflect films. Specifically, in this embodiment, the light modulation unit 250 is composed of a compound of ramifications of niobium and silicon which are adhered on the first substrate 222. In another embodiment, the compound of ramifications of niobium and silicon can also be deposited onto the first substrate 222 via vacuum coating, ion plating, or magnetron sputtering. In another embodiment, the compound of ramifications of niobium and silicon can also be doped into the first substrate 222.

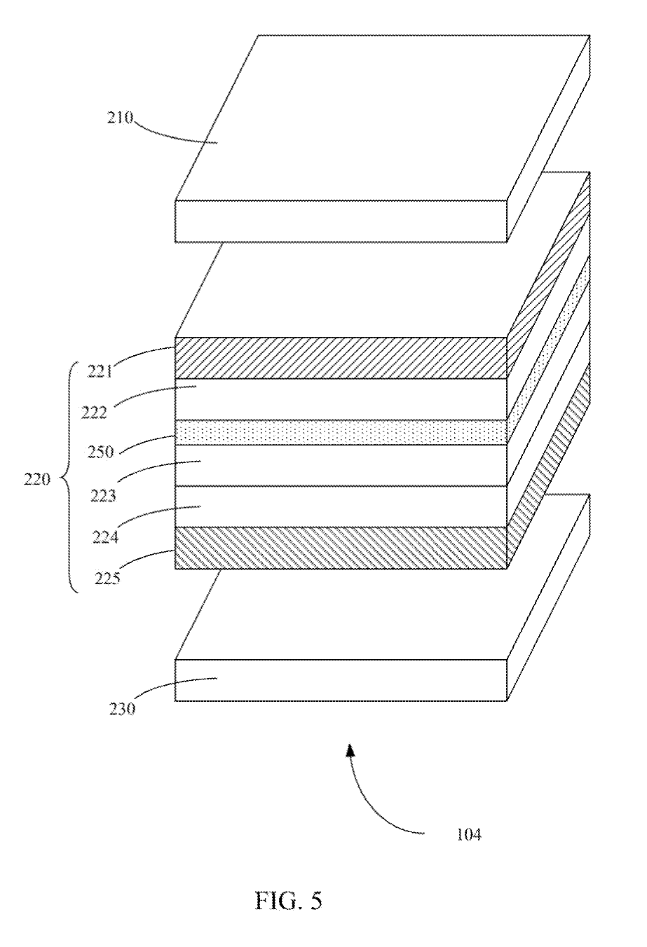

FIG. 5 is a fourth embodiment of a display device 104. The display device 104 is similar to the display device 103 in the third embodiment. Specifically, the display device 104 can also include the protection layer 210, the first polarizer 221, the first substrate 222, the liquid crystal layer 223, the second substrate 224, the second polarizer 225, the light modulation unit 250, and the backlight module 230 as well as the display device 103 in the third embodiment. The difference between the display device 104 and the display device 103 is that the light modulation unit 250 is disposed on one surface of the first substrate 222 away from the first polarizer 221. The light modulation unit 250 includes one or more absorb films or one or more reflect films. Specifically, in this embodiment, the light modulation unit 250 is composed of a compound of ramifications of niobium and silicon which are adhered on the first substrate 222. In another embodiment, the compound of ramifications of niobium and silicon can also be deposited onto the first substrate 222 via vacuum coating, ion plating, or magnetron sputtering. In another embodiment, the compound of ramifications of niobium and silicon can also be doped into the first substrate 222.

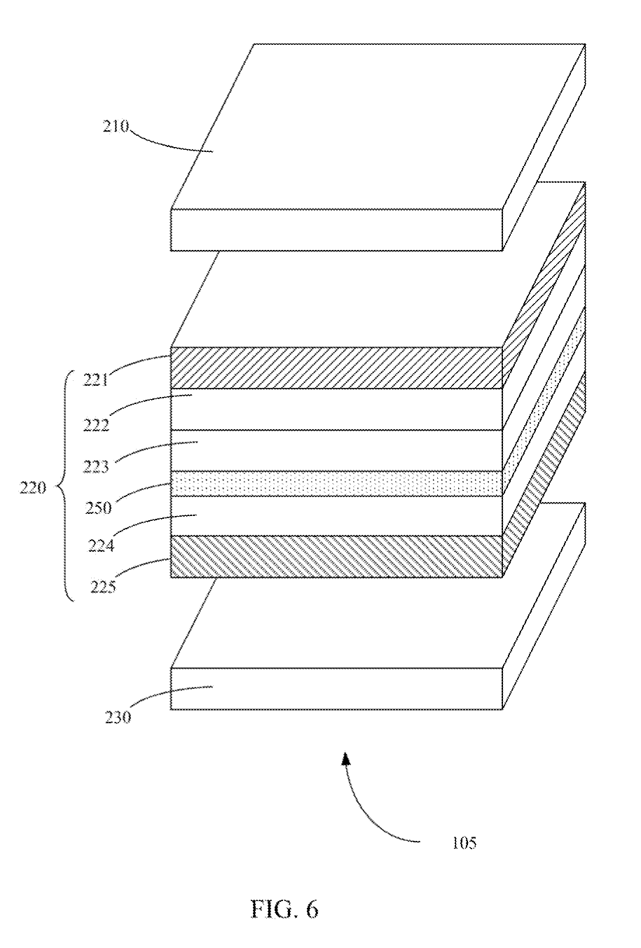

FIG. 6 is a fifth embodiment of a display device 105. The display device 105 is similar to the display device 101 in the first embodiment. Specifically, the display device 105 can also include the protection layer 210, the first polarizer 221, the first substrate 222, the liquid crystal layer 223, the second substrate 224, the second polarizer 225, the light modulation unit 250, and the backlight module 230 as well as the display device 101 in the first embodiment. The difference between the display device 105 and the display device 101 is that the light modulation unit 250 is disposed on one side of the second substrate 224 away from the second polarizer 225. The light modulation unit 250 includes one or more absorb films or one or more reflect films. Specifically, in this embodiment, the light modulation unit 250 is composed of a compound of ramifications of niobium and silicon which are adhered on the second substrate 224. In another embodiment, the compound of ramifications of niobium and silicon can also be deposited onto the second substrate 224 via vacuum coating, ion plating, or magnetron sputtering. In another embodiment, the compound of ramifications of niobium and silicon can also be doped into the second substrate 224.

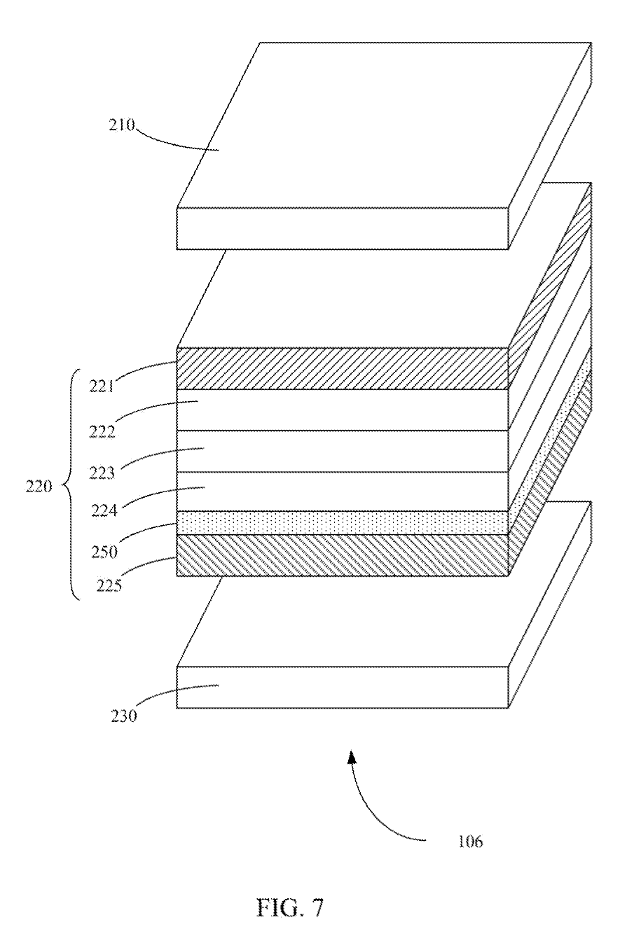

FIG. 7 is a sixth embodiment of a display device 106. The display device 106 is similar to the display device 105 in the fifth embodiment. Specifically, the display device 106 can also include the protection layer 210, the first polarizer 221, the first substrate 222, the liquid crystal layer 223, the second substrate 224, the second polarizer 225, the light modulation unit 250, and the backlight module 230 as well as the display device 105 in the fifth embodiment. The difference between the display device 106 and the display device 105 is that the light modulation unit 250 is disposed on one side of the second substrate 224 adjacent to the second polarizer 225. The light modulation unit 250 includes one or more absorb films or one or more reflect films. Specifically, in this embodiment, the light modulation unit 250 is composed of a compound of ramifications of niobium and silicon which are adhered on the second substrate 224. In another embodiment, the compound of ramifications of niobium and silicon can also be deposited onto the second substrate 224 via vacuum coating, ion plating, or magnetron sputtering. In another embodiment, the compound of ramifications of niobium and silicon can also be doped into the second substrate 224.

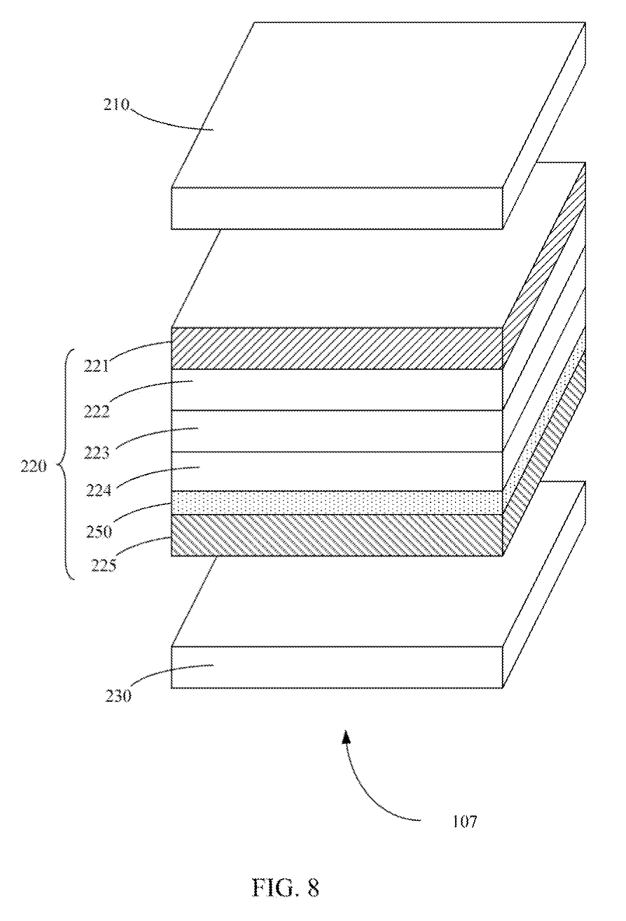

FIG. 8 is a seventh embodiment of a display device 107. The display device 107 is similar to the display device 101 in the first embodiment. Specifically, the display device 107 can also include the protection layer 210, the first polarizer 221, the first substrate 222, the liquid crystal layer 223, the second substrate 224, the second polarizer 225, the light modulation unit 250, and the backlight module 230 as well as the display device 101 in the first embodiment. The difference between the display device 107 and the display device 101 is that the light modulation unit 250 is disposed on one side of the second polarizer 225 adjacent to the second substrate 224. The light modulation unit 250 includes one or more absorb films or one or more reflect films. Specifically, in this embodiment, the light modulation unit 250 is composed of a compound of ramifications of niobium and silicon which are adhered on the second polarizer 225. In another embodiment, the compound of ramifications of niobium and silicon can also be deposited onto the second polarizer 225 via vacuum coating, ion plating, or magnetron sputtering. In another embodiment, the compound of ramifications of niobium and silicon can also be doped into the second polarizer 225.

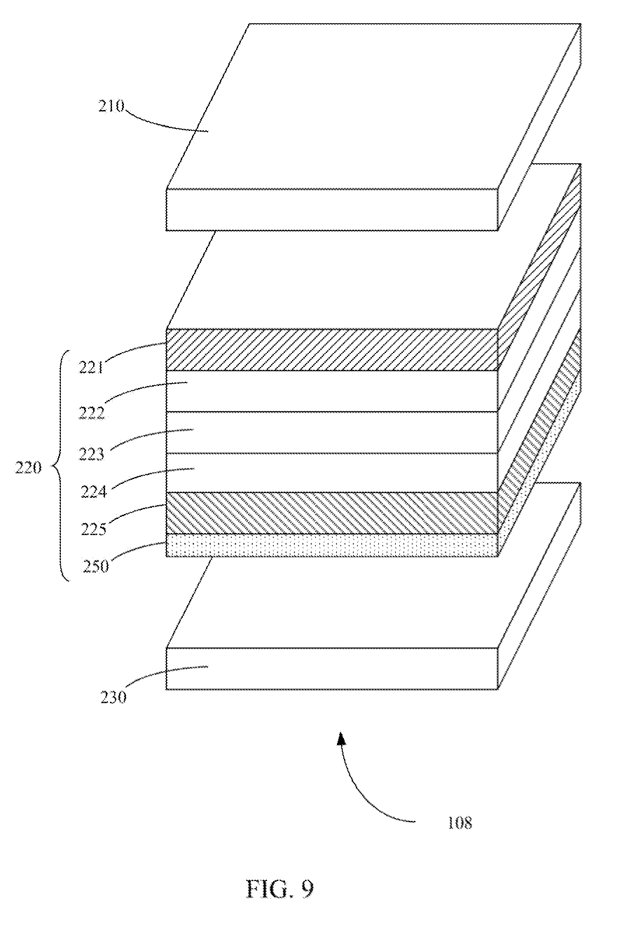

FIG. 9 is an eighth embodiment of a display device 108. The display device 108 is similar to the display device 107 in the seventh embodiment. Specifically, the display device 108 can also include the protection layer 210, the first polarizer 221, the first substrate 222, the liquid crystal layer 223, the second substrate 224, the second polarizer 225, the light modulation unit 250, and the backlight module 230 as well as the display device 107 in the seventh embodiment. The difference between the display device 108 and the display device 107 is that the light modulation unit 250 is disposed on one side of the second polarizer 225 away from the second substrate 224. The light modulation unit 250 includes one or more absorb films or one or more reflect films. Specifically, in this embodiment, the light modulation unit 250 is composed of a compound of ramifications of niobium and silicon which are adhered on the second substrate 224. In another embodiment, the compound of ramifications of niobium and silicon can also be deposited onto the second substrate 224 via vacuum coating, ion plating, or magnetron sputtering. In another embodiment, the compound of ramifications of niobium and silicon can also be doped into the second substrate 224.

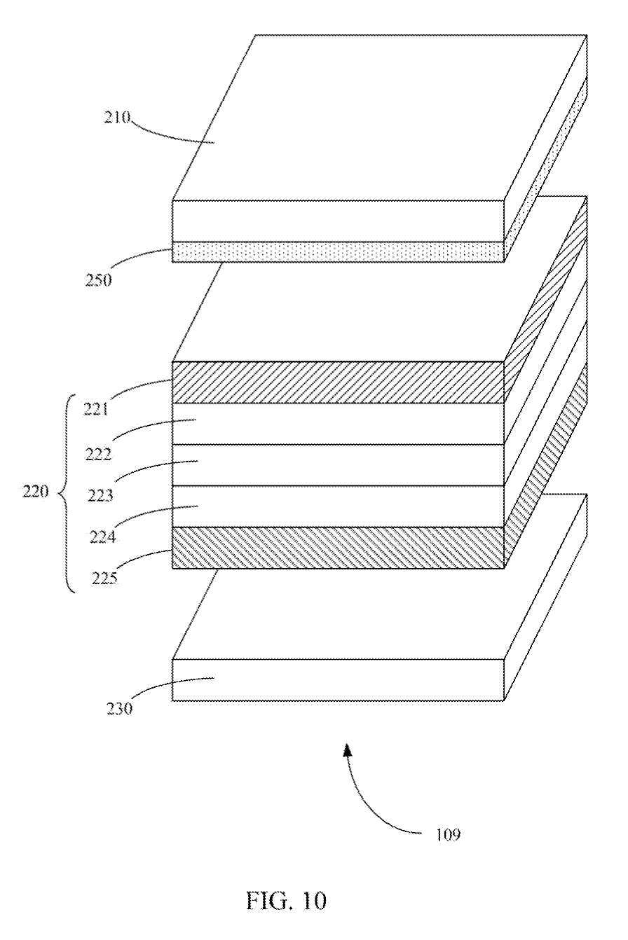

FIG. 10 is a ninth embodiment of a display device 109. The display device 109 is similar to the display device 101 in the first embodiment. Specifically, the display device 109 can also include the protection layer 210, the first polarizer 221, the first substrate 222, the liquid crystal layer 223, the second substrate 224, the second polarizer 225, the light modulation unit 250, and the backlight module 230 as well as the display device 101 in the first embodiment. The difference between the display device 109 and the display device 101 is that the light modulation unit 250 is disposed on one side of the protection layer 210 adjacent to the display panel 220. The light modulation unit 250 includes one or more absorb films or one or more reflect films. Specifically, in this embodiment, the light modulation unit 250 is composed of a compound of ramifications of niobium and silicon which are adhered on the protection layer 210. In another embodiment, the compound of ramifications of niobium and silicon can also be deposited onto the protection layer 210 via vacuum coating, ion plating, or magnetron sputtering. In another embodiment, the compound of ramifications of niobium and silicon can also be doped into the protection layer 210.

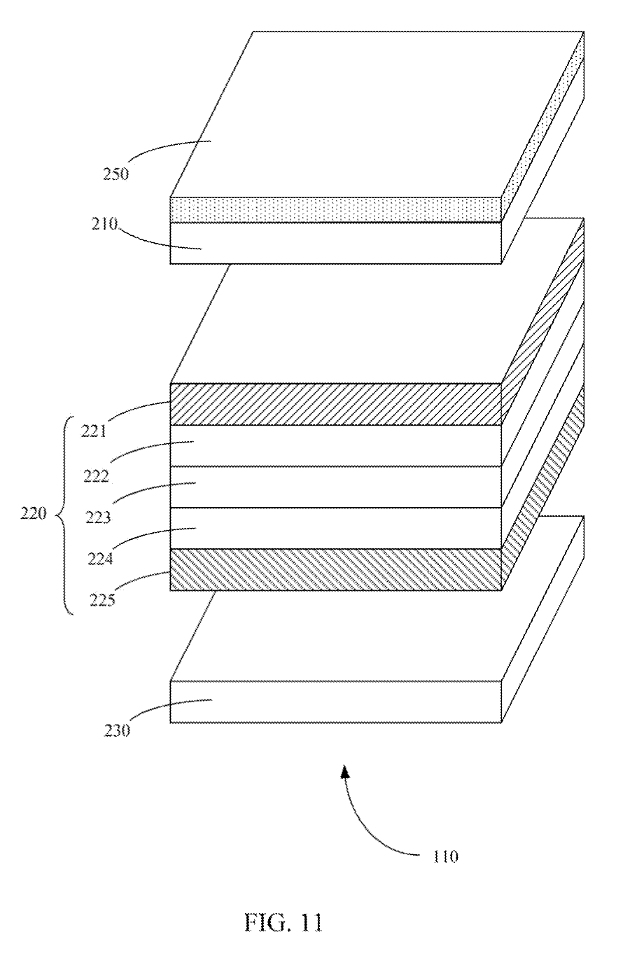

FIG. 11 is a tenth embodiment of a display device 110. The display device 110 is similar to the display device 109 in the ninth embodiment. Specifically, the display device 110 can also include the protection layer 210, the first polarizer 221, the first substrate 222, the liquid crystal layer 223, the second substrate 224, the second polarizer 225, the light modulation unit 250, and the backlight module 230 as well as the display device 109 in the ninth embodiment. The difference between the display device 110 and the display device 109 is that the light modulation unit 250 is disposed on one side of the protection layer 210 away from the display panel 220. The light modulation unit 250 includes one or more absorb films or one or more reflect films. Specifically, in this embodiment, the light modulation unit 250 is composed of a compound of ramifications of niobium and silicon which are adhered on the protection layer 210. In another embodiment, the compound of ramifications of niobium and silicon can also be deposited onto the protection layer 210 via vacuum coating, ion plating, or magnetron sputtering. In another embodiment, the compound of ramifications of niobium and silicon can also be doped into the protection layer 210.

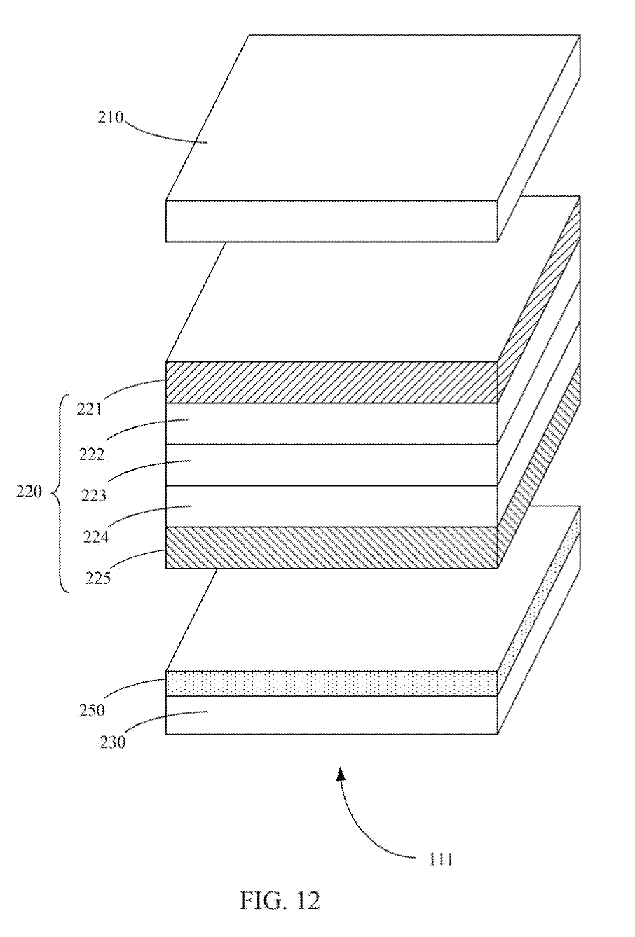

FIG. 12 is an eleventh embodiment of a display device 111. The display device 111 is similar to the display device 110 in the tenth embodiment. Specifically, the display device 111 can also include the protection layer 210, the first polarizer 221, the first substrate 222, the liquid crystal layer 223, the second substrate 224, the second polarizer 225, the light modulation unit 250, and the backlight module 230 as well as the display device 110 in the tenth embodiment. The difference between the display device 111 and the display device 110 is that the light modulation unit 250 is disposed on one side of the backlight module 230 adjacent to the display panel 220. The light modulation unit 250 includes one or more absorb films or one or more reflect films. Specifically, in this embodiment, the light modulation unit 250 is composed of a compound of ramifications of niobium and silicon which are adhered on the backlight module 230. In another embodiment, the compound of ramifications of niobium and silicon can also be deposited onto the backlight module 230 via vacuum coating, ion plating, or magnetron sputtering. In another embodiment, the compound of ramifications of niobium and silicon can also be doped into the backlight module 230.

In the first embodiment to the eleventh embodiment above mentioned, the blue light having a wavelength in a range from 415 nm to 455 nm is reduced by the light modulation unit 250. In other embodiments, we can also reduce a portion of blue light having a wavelength in a range from 415 nm to 455 nm by using a backlight module which provides light including blue light, wherein peak wavelength in the spectrum if the blue light is not less than 455 nm.

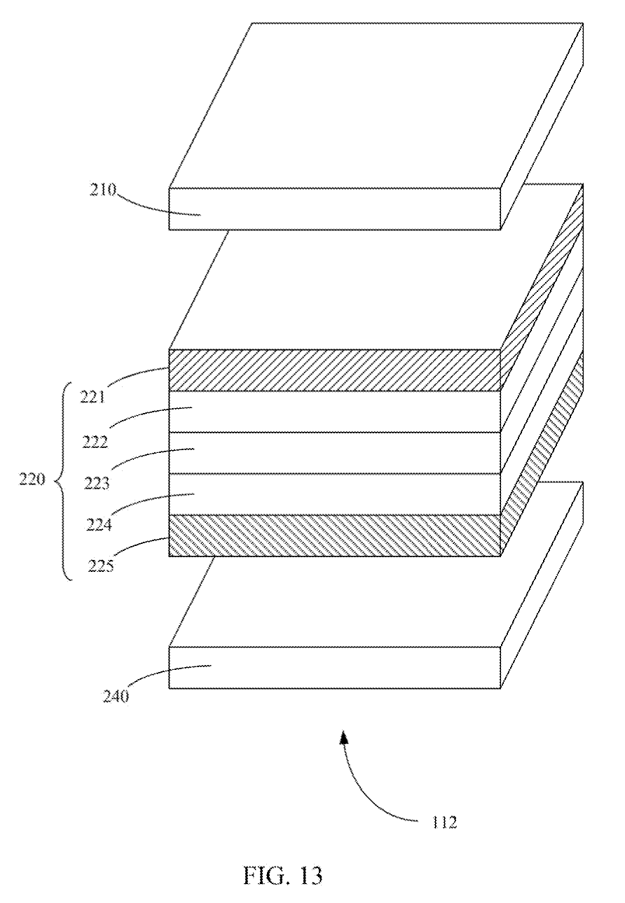

FIG. 13 is a twelfth embodiment of a display device 112. The display device 112 is similar to the display device 111 in the eleventh embodiment. Specifically, the display device 112 includes the protection layer 210 and the display panel 220 as well as the display device 111 in the eleventh embodiment. The difference between the display device 112 and the display device 111 is that the light emitted from the backlight module 240 includes blue light which peak wavelength in a spectrum is not less than 455 nm. Preferably, a peak wavelength of the blue light emitted from the backlight module 240 is in a range from 460 nm to 480 nm.

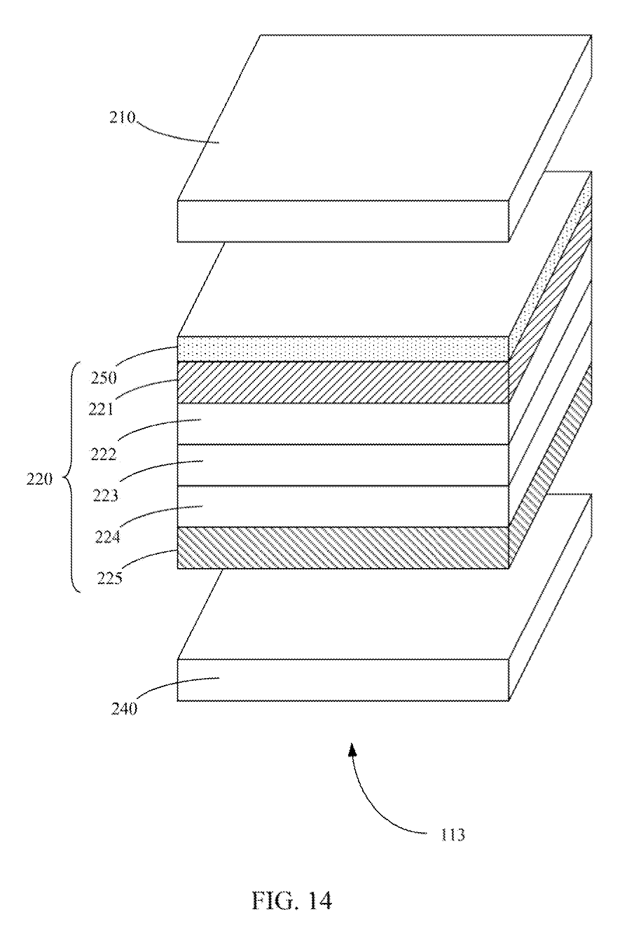

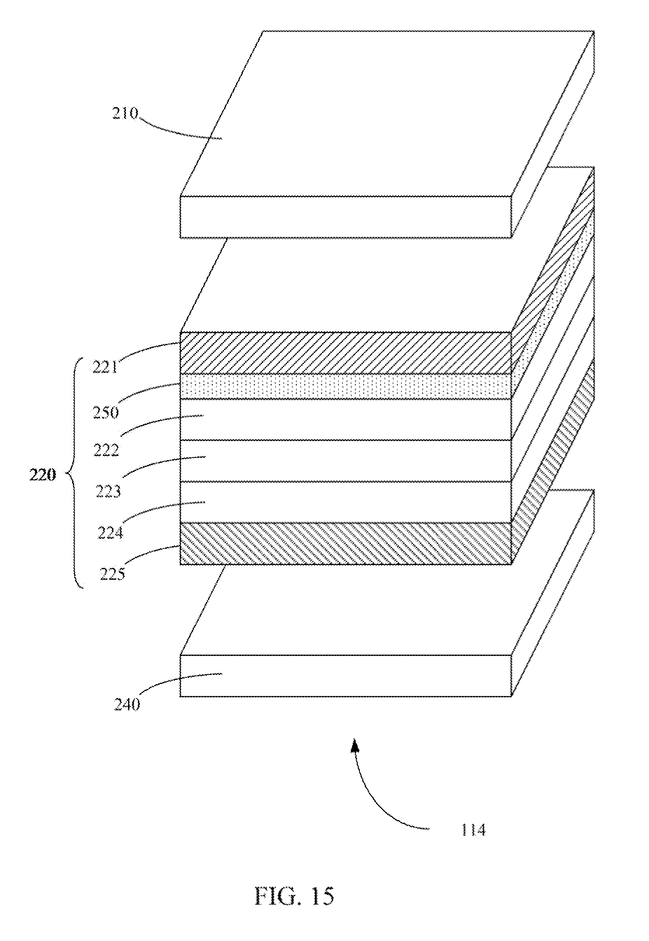

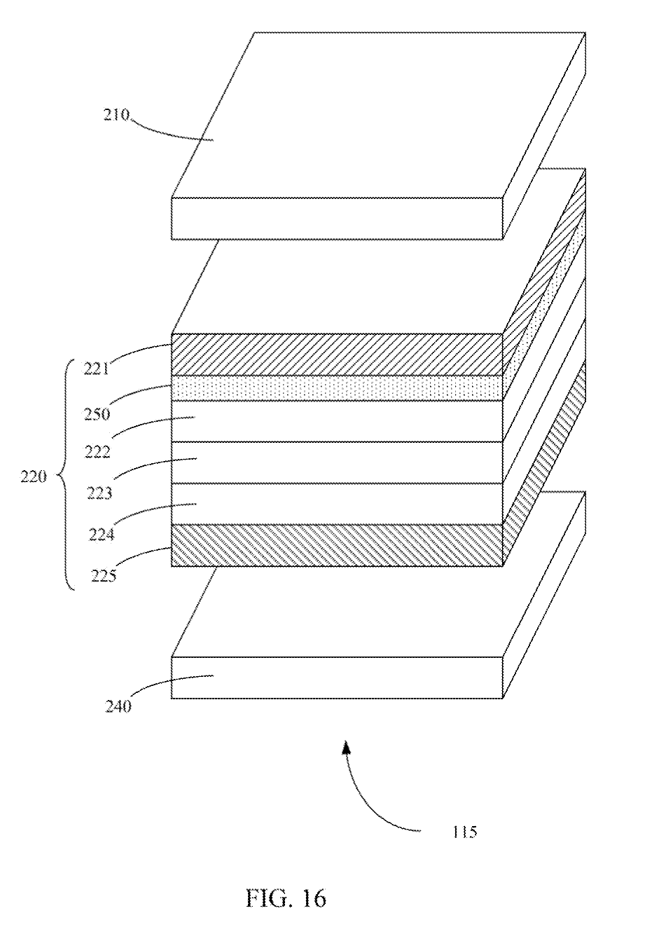

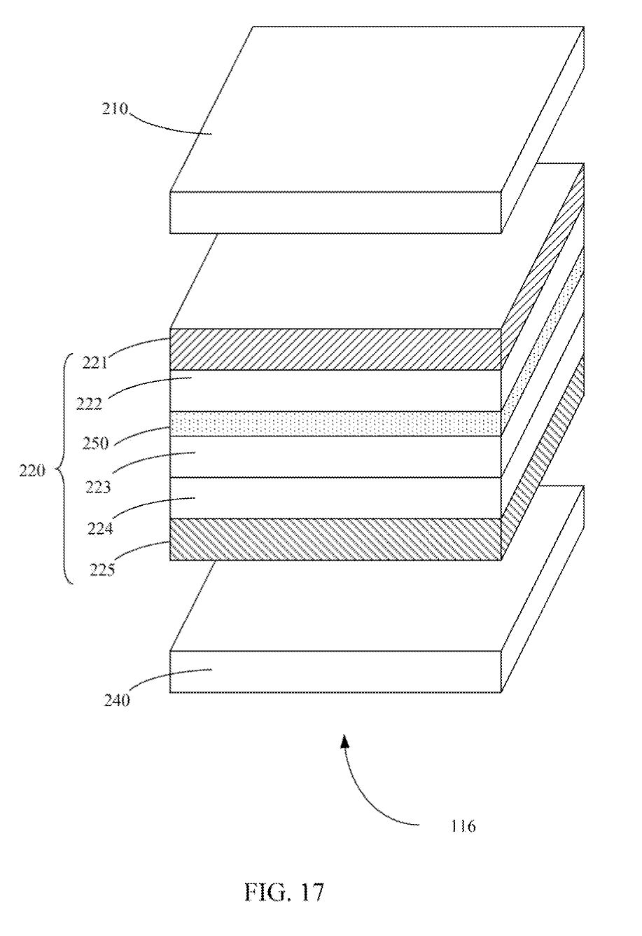

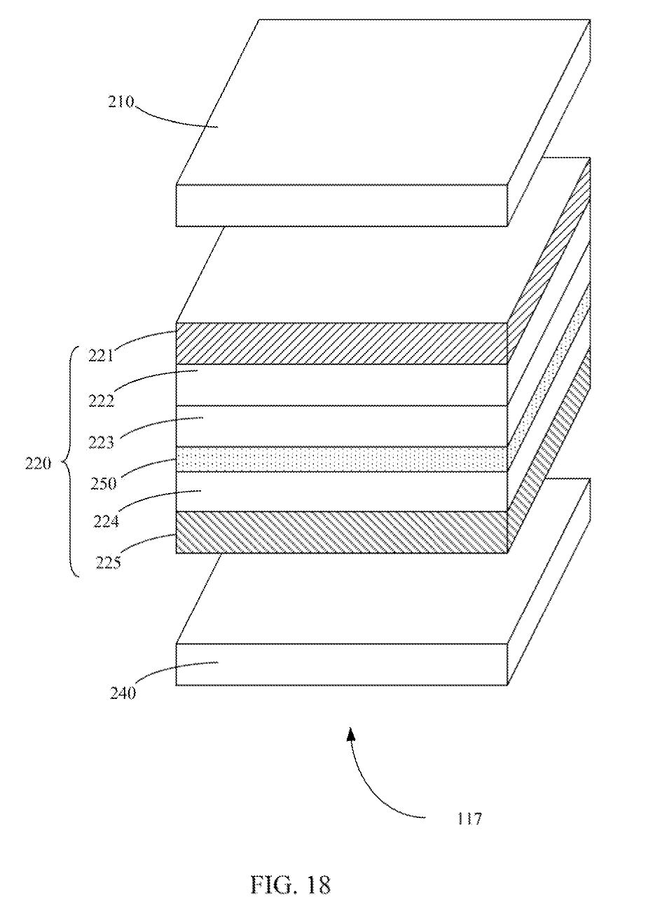

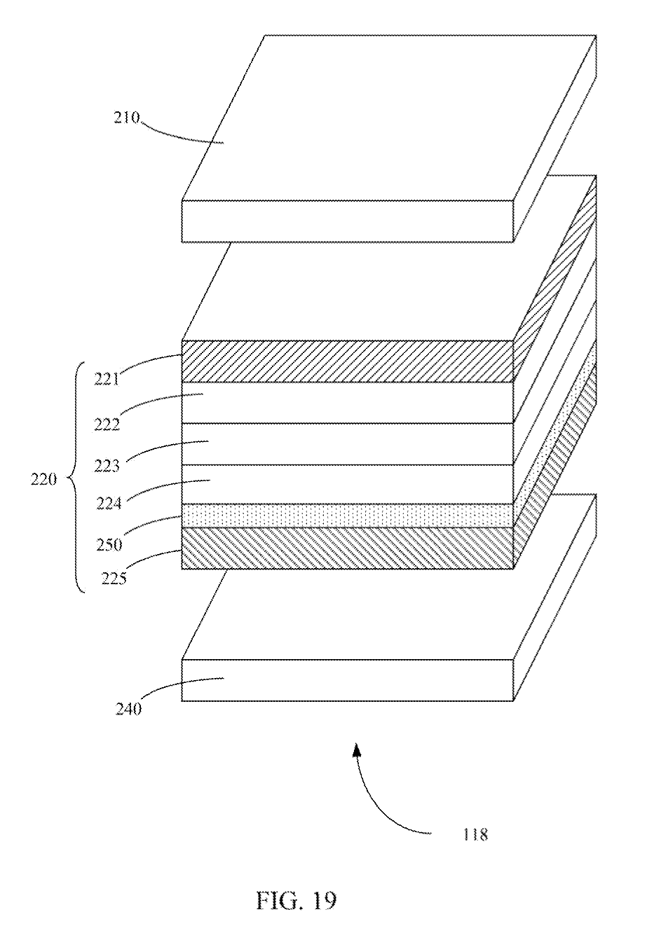

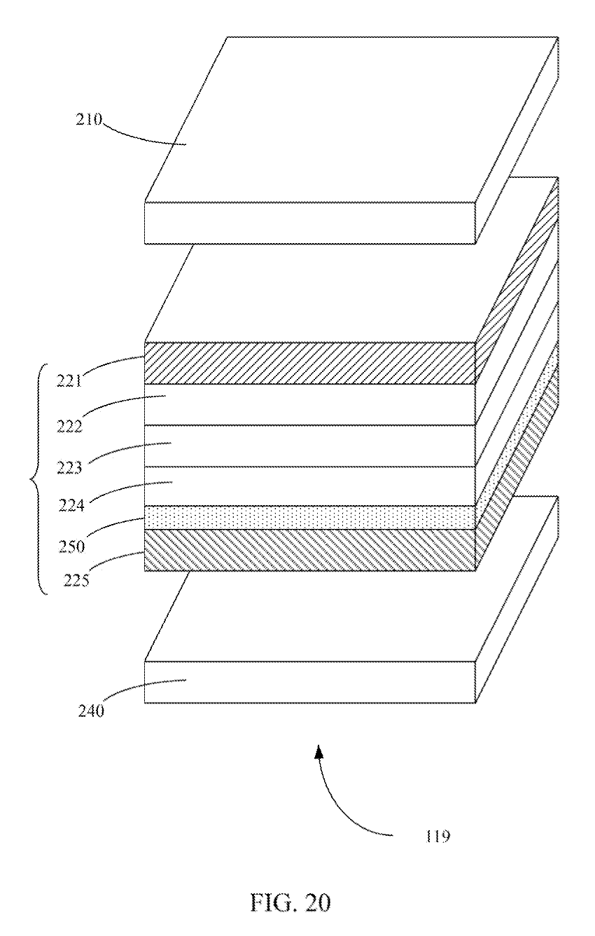

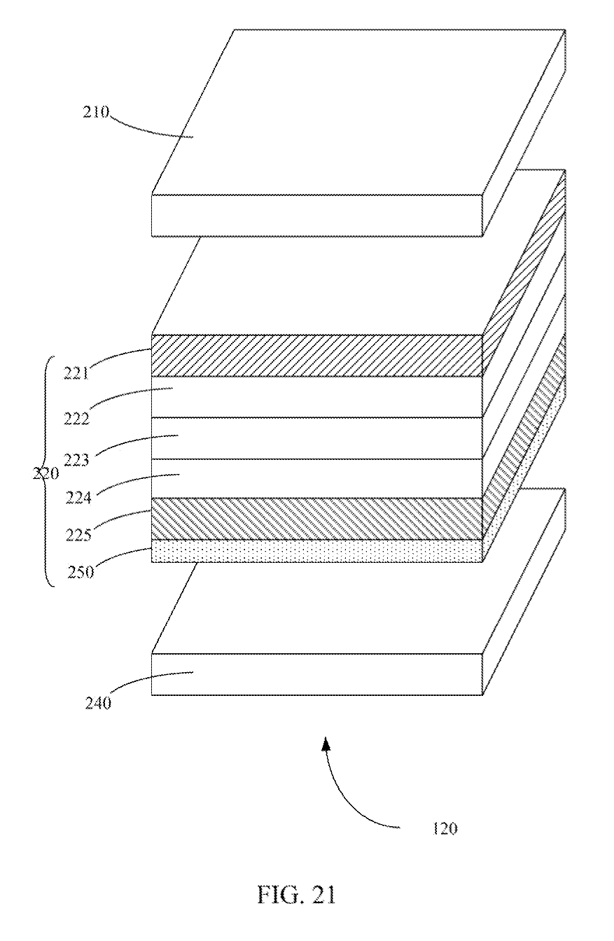

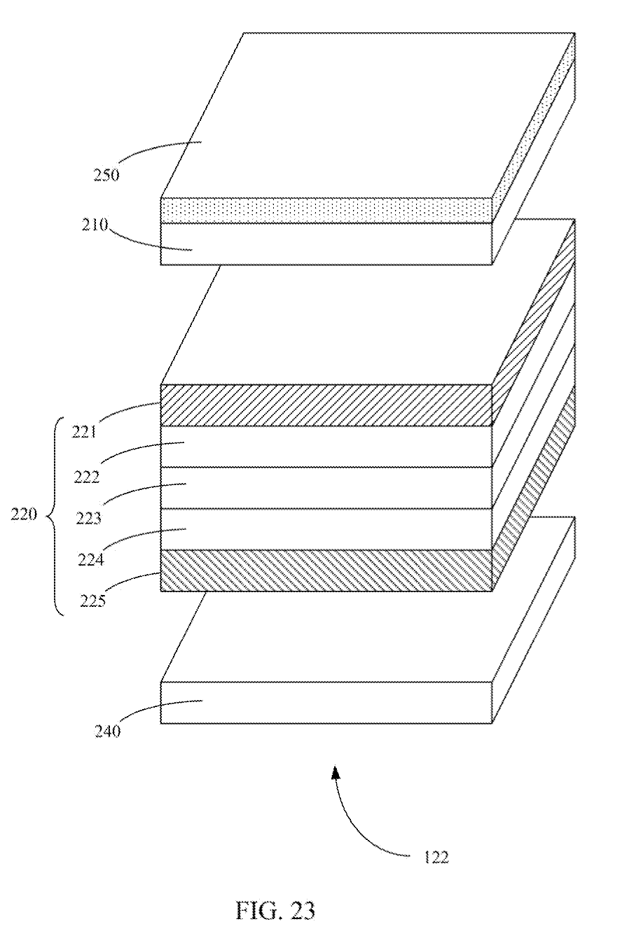

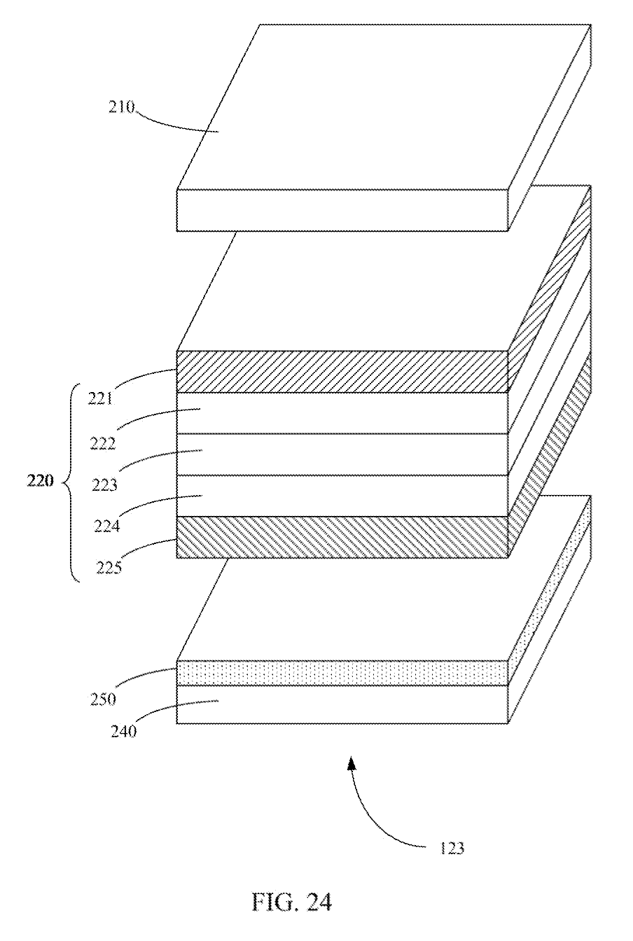

It is understood that, the backlight module 240 in the twelfth embodiment can be collocated with the light modulation unit 250 in each of the first to the eleventh embodiments. FIGS. 14 to 24 show eleven embodiments of display devices 113 to 123 which are collocated the backlight module 240 of the twelfth embodiment with each of the light modulation unit 250 of the first to the eleventh embodiments.

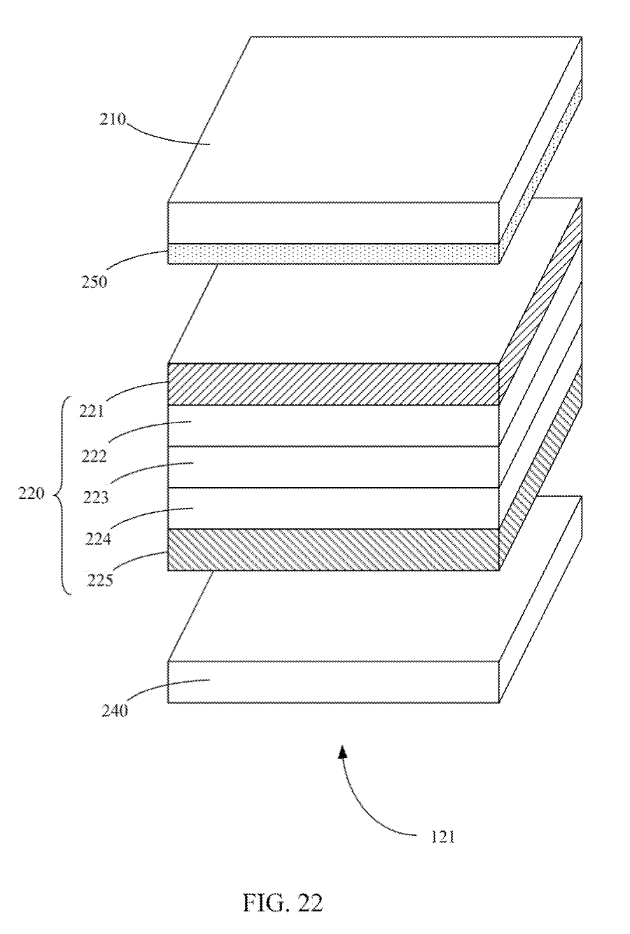

It's necessary to note that, FIG. 22 shows a preferred embodiment of a display device 121. In this embodiment, the light modulation unit 250 is disposed on one side of the protection layer 210 adjacent to the display panel 220, thus, the light modulation unit 250 can reduce blue light emitted through the whole display panel 220, and can be protected by the protection layer 210. In addition, the backlight module 230 provides light including blue light, wherein peak wavelength in the spectrum if the blue light is not less than 455 nm, so the damage to our eyes is mostly averted.

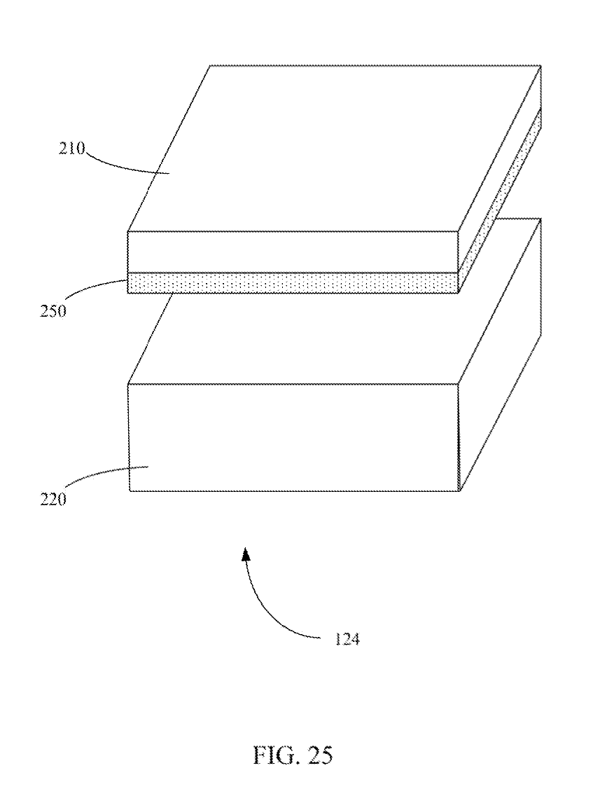

FIG. 25 shows a twenty-fourth embodiment of a display device 124. The display device 124 includes a protection layer 210, a display panel 220, and a light modulation unit 250. In this embodiment, the display panel 220 can be an OLED (Organic Light Emitting Diode) display panel or a PDP (Plasma Display Panel). The protection layer 210 is a cover glass covering the display panel 220. The light modulation unit 250 reduces a portion of blue light having a wavelength in a range from 415 nm to 455 nm emitted from the display device 124.

In this embodiment, a transmittance of the light modulation unit 250 for blue light in a wavelength less than 450 nm is less than 10%, a transmittance of the light modulation unit 250 for blue light having a wavelength over 470 nm is not less than 90%, and a transmittance of the light modulation unit 250 for blue light having a wavelength in a range from 450 nm to 470 nm increases when the wavelength of the blue light increases. In this embodiment, the light modulation unit 250 is disposed on one side of the protection layer 210 adjacent to the display panel 220.

In conclusion, the embodiments of the present disclosure adjust a peak wavelength of the blue light emitted from the display device to reduce the harmful of the blue light to eyes of people, and thus, the damages are averted.

The embodiments shown and described above are only examples. Many details are often found in the art such as the other features of a display device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A display device comprising:
a display panel; and
a backlight module configured to emit light to the display panel, the light emitted from the backlight module comprising blue light having a peak wavelength not less than 455 nm.

2. The display device of claim 1, wherein a peak wavelength of the blue light emitted from the backlight module is in a range from 460 nm to 480 nm.

3. The display device of claim 1, further comprising a light modulation unit configured to reduce a portion of the blue light having a wavelength in a range from 415 nm to 455 nm emitted from the display device.

4. The display device of claim 3, wherein a transmittance of the light modulation unit for blue light in a wavelength less than 450 nm is less than 10%, and a transmittance of the light modulation unit for blue light having a wavelength over 470 nm is not less than 90%.

5. The display device of claim 4, wherein a transmittance of the light modulation unit for blue light having a wavelength in a range from 450 nm to 470 nm increases when the wavelength of blue light increases.

6. The display device of claim 3, wherein the light modulation unit comprises one or more absorb films.

7. The display device of claim 3, wherein the light modulation unit comprises one or more reflect films.

8. The display device of claim 3, wherein the light modulation unit is composed of a compound of ramifications of niobium and silicon which are adhered on the display device, deposited onto the display device, or doped into the display device.

9. The display device of claim 3, wherein the display panel comprises a number of first films, the light modulation unit is composed of a compound of ramifications of niobium and silicon which are adhered on one of the first films, deposited onto one of the first films, or doped into one of the first films.

10. The display device of claim 3, wherein the display device further comprises a protection layer, the protection layer covers the display panel, the light modulation unit is composed of a compound of ramifications of niobium and silicon which are adhered on the protection layer, deposited onto the protection layer, or doped into the protection layer.

11. The display device of claim 3, wherein the light modulation unit is composed of a compound of ramifications of niobium and silicon which are adhered on the backlight module, deposited onto the backlight module, or doped into the backlight module.

12. A display device comprising:
a light modulation unit configured to reduce a portion of the blue light having a wavelength in a range from 415 nm to 455 nm emitted from the display device.

13. The display device of claim 12, wherein a transmittance of the light modulation unit for blue light in a wavelength less than 450 nm is less than 10%, and a transmittance of the light modulation unit for blue light having a wavelength over 470 nm is not less than 90%.

14. The display device of claim 13, wherein a transmittance of the light modulation unit for blue light having a wavelength in a range from 450 nm to 470 nm increases when the wavelength of blue light increases.

15. The display device of claim 12, wherein the display device comprises a display panel, the display panel comprises a number of first films, the light modulation unit is composed of a compound of ramifications of niobium and silicon which are adhered on one of the first films, deposited onto one of the first films, or doped into one of the first films.

16. The display device of claim 15, wherein the display panel further comprises a liquid crystal layer, the first films comprise a first polarizer, a first substrate, a second substrate, and a second polarizer, the first substrate is opposite to the second substrate, the liquid crystal layer is disposed between the first substrate and the second substrate, the first polarizer is disposed at one side of the first substrate away from the liquid crystal layer, the second polarizer is disposed at one side of the second substrate away from the liquid crystal layer.

17. The display device of claim 12, wherein the display device comprises a protection layer and a display panel, the protection layer covers the display panel, the light modulation unit is composed of a compound of ramifications of niobium and silicon which are adhered on the protection layer, deposited onto the protection layer, or doped into the protection layer.

18. The display device of claim 12, wherein the display device comprises a display panel and a backlight module, the backlight module emits light to the display panel, the light modulation unit is composed of a compound of ramifications of niobium and silicon which are adhered on the backlight module, deposited onto the backlight module, or doped into the backlight module.

19. The display device of claim 12, wherein the light modulation unit comprises one or more absorb films.

20. The display device of claim 12, wherein the light modulation unit comprises one or more reflect films.
